(19) United States
(12) Patent Application Publication
(10) Pub. No.: US 2019/0139081 A1
(43) Pub. Date: May 9, 2019

(54) CONVERSION ACTIVITY RELATING TO IN-MAP ADVERTISEMENTS

(71) Applicant: GOOGLE INC., (US)

(72) Inventors: Jordan John BAYLISS-MCCULLOCH, Beaconsfield (AU); Andrew FOSTER, Naremburn (AU); Smita HASHIM, Saratoga, CA (US)

(73) Assignee: GOOGLE INC., Mountain View, CA (US)

(21) Appl. No.: 13/891,137

(22) Filed: May 9, 2013

(51) Int. Cl. G06Q 30/02

(52) U.S. Cl. CPC G06Q 30/0246

(57) ABSTRACT

A machine-implemented method for recording conversion activity in response to advertisements including receiving an indication of a user interaction with an ad displayed at a webpage at a user client device, the ad being associated with at least one website, providing one or more content items relating to the ad for display at the webpage in response to the indication of user interaction, providing a conversion cookie to the user client device for the at least one webpage in response to the indication of user interaction, where the conversion cookie causes the browser to send an indication of a conversion activity when a conversion activity occurs in response to a user visiting the webpage, receiving, at a time after the providing of the conversion cookie, an indication of a conversion activity in response to a user performing a conversion activity and associating the conversion activity with the ad.

### BACKGROUND

Advertisement content (“ads”) relating to user requested content may be selected and displayed to a user, to help monetize content being provided to users and providing users with offers and promotions relating to user activity. In one example, ads can be embedded in content displayed to a user, such as for example, in interactive maps being provided for display at user devices. Advertisers typically pay for placing ads to promote certain user activity with respect to a business. Conversion activity typically includes advertiser-defined events (e.g., purchases, reviews, viewing of content, etc.) that occur following user interaction with an ad. Usually, conversions occur following an ad landing page click. That is, the user interacts with an ad, causing the user to be redirected to a landing page, and the user activity following the user visiting the landing page determines if a conversion activity has occurred. However, in addition to a user being redirected to an ad landing page, a user may perform a conversion activity in response to other events relating to an ad (e.g., reviews, organic link, photos, etc.). It would be helpful to facilitate recording conversions independent of user clicking on an ad landing page link.

### SUMMARY

The disclosed subject matter relates to a machine-implemented method for recording conversion activity in response to advertisements, the method comprising receiving, using one or more computing devices, an indication of a user interaction with an ad provided for display at a webpage within a browser at a user client device, wherein the ad is associated with at least one website of an entity. The method further comprising providing, using the one or more computing devices, one or more content items relating to the ad for display at the webpage within the browser at the user client device in response to the indication of user interaction. The method further comprising providing, using the one or more computing devices, a conversion cookie to the user client device for the at least one webpage in response to the indication of user interaction, wherein the conversion cookie causes the browser to send an indication of a conversion activity when a conversion activity occurs in response to a user visiting the webpage. The method further comprising receiving, at a time after the providing of the conversion cookie, using the one or more computing devices, an indication of a conversion activity in response to a user performing a conversion activity and associating the conversion activity with the ad.

The disclosed subject matter also relates to a system for recording conversion activity in response to advertisements, the system comprising one or more processors and a machine-readable medium comprising instructions stored therein, which when executed by the processors, cause the processors to perform operations comprising receiving an indication of a user interaction with an object associated with an ad provided for display at a user device, wherein the ad is associated with an entity. The operations further comprising providing one or more content items relating to the entity for display at the user client device in response to the indication of user interaction. The operations further comprising providing a conversion cookie to the user client device for at least one webpage associated with the ad in response to the indication of user interaction with the entity without redirecting the user to the at least one webpage. The operations further comprising receiving, at a time after the providing of the conversion cookie, an indication of a conversion activity by a user following the user visiting the at least one webpage at the client device and associating the conversion activity with the ad.

The disclosed subject matter also relates to a machine-readable medium comprising instructions stored therein, which when executed by a machine, cause the machine to perform operations comprising receiving a request to monitor conversion activity with respect to an ad in response to user interaction with the ad. The operations further comprising providing the ad for display to one or more users at one or more user devices. The operations further comprising receiving an indication of a user interaction with the ad at at least one user device of the one or more user devices, the user interaction comprising an expansion of the ad, the expansion causing one or more content items relating to an entity relating to the ad for display at the at least one user client device. The operations further comprising providing a conversion cookie to the at least one user device for at least one webpage associated with the ad in response to the indication of user interaction with the ad without redirecting the user to the at least one webpage. The operations further comprising receiving, at a time after the providing of the conversion cookie, an indication of a conversion activity in response to a user visiting the at least one webpage at the at least one user device and associating the conversion activity with the ad in response to the indication of the conversion activity.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for recording conversions resulting from an ad based on user interaction with an ad.

FIG. 2 illustrates a flow diagram of an example process for recording conversions resulting from an ad based on user interaction with an ad.

FIG. 3 illustrates an example user interface providing a map displaying map content and ads for display to a user.

FIG. 4 illustrates an example user interface providing content items for display to a user in response to an ad interaction event.

FIG. 5 illustrates an example user interface providing a conversion setting menu that may be provided for display to an advertiser.

FIG. 6 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The present disclosure provides a method and system for facilitating recording conversions resulting from an ad based on user interaction with an ad, independent of whether the user clicks on an ad landing page and/or is redirected to the ad landing page. A conversion may be any action that a user takes on an advertiser website that has value to the business of the advertiser, including purchases, subscriptions, reviews or views of a page. In traditional systems, recording conversion begins once a link leading to an ad landing page being displayed to a user is clicked and the user is redirected to the landing page. Thus, a conversion activity by a user is recognized after the user had visited the landing page. However, such redirecting may cause a redirecting of the user from content being provided to user at the page as a result of user request and/or activity and may further distract the user experience because the user would be redirected from the main page showing the organic content (e.g., search results, maps, etc.) to the user.

Recording conversion activity based on user interaction with an ad or entity associated with an ad independent of redirecting the user to a landing page is facilitated by defining an event upon detecting user interaction with a displayed object associated with an ad. In one example, ads may be embedded into organic content (e.g., map content or other data) provided for display to a user. Ads may be clustered with entities relating to the ad (e.g., the business advertised). In some examples, interactions with an ad and/or the entity associated with the ad (e.g., a business) may lead to content items regarding the ad being displayed to a user. In one example, user interaction with the ad or entity associated with the ad is recognized as an ad interaction event. In one example, the interaction may include a mouse-click, mouse-hover, or otherwise selection or highlighting of an icon representing the ad and/or associated entity by the user, for example, using a user input device. In response to receiving an indication of an ad interaction event, content items relating to the entity and/or ad may be displayed to the user. The content items displayed to a user in response to an interaction event may include content items relating to the entity and/or the ad, and/or one or more links to activities and/or services relating to the entity and/or ad, including, for example, direction services, social networking services, review services, website(s), and other content items or services.

Upon receiving an ad interaction event, a request is sent (e.g., to a third party server) to set a conversion cookie for one or more pages associated with the advertisement (e.g., a main page, a landing page, etc.). Cookies are short pieces of data that can be used to identify a user or web browser. Where cookies identifying a user or user browsing activity are being sent as part of the recording of conversion activity, the user may set whether the browser accepts cookies from one or more entities. In one example, a browser setting may be provided to allow the user to allow cookies from one or more entities or to disable cookies from all entities. In some implementations, the user may choose to receive a notification when a cookie is being sent from an entity to decide whether to allow the cookie. In some examples, mechanisms other than cookies may be used to record conversion activity associated with an ad. In these instances, where user activity is viewable and may be recorded when leading to conversion activity, similar settings may be provided to the user to provide the user notice and/or control of such activity.

In response to the request, a conversion cookie is sent to the browser, without requiring the user to be redirected from the page where the organic content is being displayed, and while the user is interacting with the organic content and/or content items being displayed in response to the interaction. In some embodiments, as described above, a user may adjust the settings indicating whether to allow cookies to be successfully sent to or stored by the browser, and the cookie will only successfully be sent to or stored by the browser based on these settings. Once the cookie is sent to the browser, at any time during the life span of the cookie and/or a set conversion period (e.g., 30 days) the system may receive an indication of a conversion activity after the user visits the page associated with the conversion cookie (e.g., ad landing page).

The visit to the page may occur from different sources including the content items displayed in response to an ad, or from review sites, social networking sites, in response to a search, or by directly typing the name of the website into the browser. At that time, the conversion cookie (e.g., a modified conversion cookie according to the visit) is retrieved and sent back the browser, for example by the entity that initially set the conversion cookie (e.g., a third party server). The conversion cookie is then sent from the browser to the ad system (e.g., upon an indication of a conversion activity), and may be used to determine conversion metrics relating to the ad. In some embodiments, the user will have to apply certain settings or install certain applications in order to take advantage of the techniques described herein.

In some examples, a micro-site may be included in the content items displayed in response to an ad interaction event, allowing advertisers or other parties to set the conversion cookie. The micro-site may be displayed as a preview of the landing page, without requiring any redirecting to the landing page itself.

II. Example Client-Server Network Environments for Recording Conversion Activity Relating to Advertisements

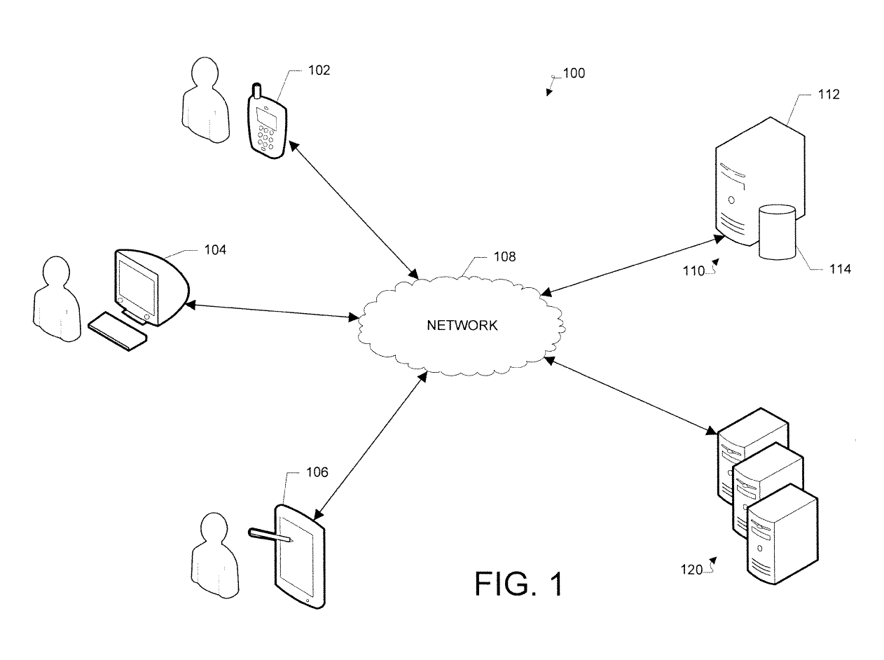

FIG. 1 illustrates an example client-server network environment which provides for recording conversions resulting from an ad based on user interaction with an ad. A network environment 100 includes a number of electronic devices 102, 104 and 106 communicably connected to a server 110 by a network 108. One or more remote servers 120 are further coupled to the server 110 and/or the one or more electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 102, 104 and 106 store a User agent such as a browser or application. In the example of FIG. 1, electronic device 102 is depicted as a smartphone, electronic device 104 is depicted as a desktop computer, and electronic device 106 is depicted as a PDA.

Server 110 includes a processing device 112 and a data store 114. Processing device 112 executes computer instructions stored in data store 114, for example, to assist in recording conversions resulting from an ad based on user interaction with an ad provided for display at electronic devices 102, 104 and 106.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host a system for displaying ads to a user and for receiving indication of user activity with respect to the displayed ad. In one example server 110 may further host a system for receiving indication of conversion activity performed by a user subsequent to the user interacting with an ad or entity related to the ad. Server 110 may further be in communication with remote servers 120 either through the network 108 or through another network or communication means.

Remote servers 120 may perform various functionalities and/or storage capabilities including search engine capabilities, ad databases, services for setting cookies or other mechanisms for recording conversion activity and/or various websites or webpages relating to an ad. Remote servers 120 may further perform functionalities and/or storage described herein with regard to the server 110 either alone or in combination with server 110. Each of the one or more remote servers 120 can be a single computing device such as a computer server or can represent more than one computing device working together to perform the actions of a server computer (e.g., cloud computing). In one embodiment server 110 and one or more remote servers 120 may be implemented as a single server or one or more remote servers. In one example, the server 110 and one or more remote servers 120 may communicate through the user agent at the client device (e.g., electronic devices 102, 104 or 106) via network 108.

Communications between the client devices 102, 104, 106, server 110 and/or one or more remote servers 120 may be facilitated through the HTTP communication protocol. Other communication protocols may also be facilitated including for example, XMPP communication, for some or all communications between the client devices 102, 104, 106, server 110 and one or more remote servers 120 (e.g., through network 108).

Users may interact with the system hosted by server 110, and/or one or more social networking services hosted by remote servers 120, through a client application such as a web based browser application installed at the electronic devices 102, 104, 106. Communication between client devices 102, 104, 106 and the one or more services, applications and websites hosted at one or more servers 110 and/or 120, may be facilitated through a network (e.g., network 108).

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Recording Conversion Activity Relating to Advertisements

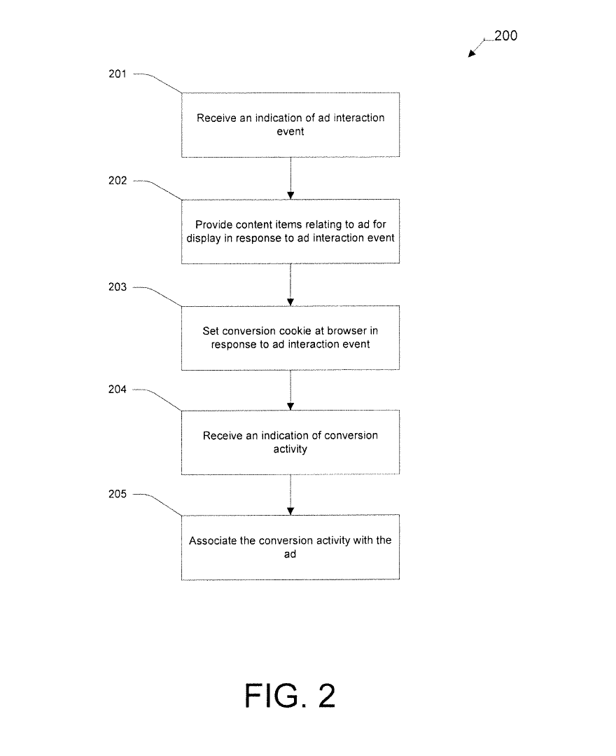

FIG. 2 illustrates a process 200 for recording conversions resulting from an ad based on user interaction with an ad.

In block 201, an indication of user interaction with an ad or an entity relating to an ad provided for display (“ad interaction event”) is received. Recording conversion activity based on user interaction with an ad or entity associated with an ad independent of redirecting the user to a landing page is facilitated by defining an event upon detecting user interaction with a displayed object associated with an ad or an entity relating to the ad. In one example, the indication may be received in response to the user interacting with a displayed icon corresponding to an ad or entity relating to the ad. The user interaction may include a mouse-click, mouse-hover, and/or or otherwise selection or highlighting of the displayed icon, using a user input device.

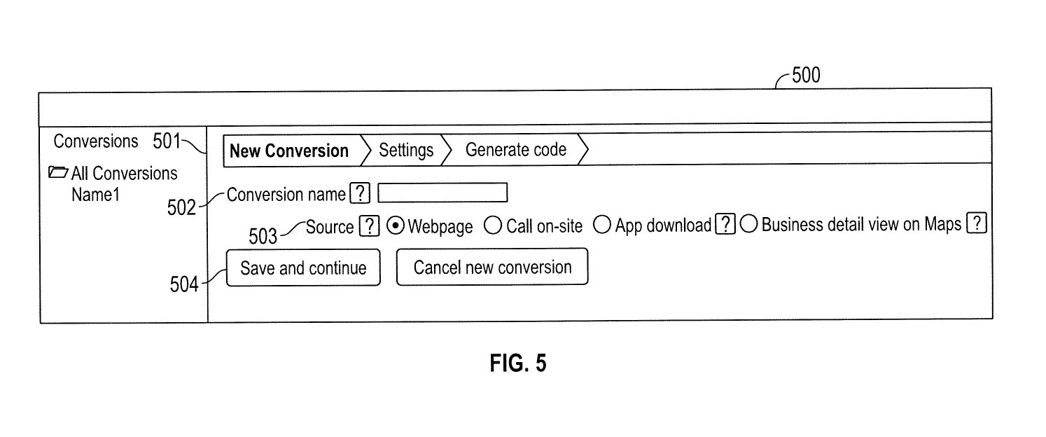

In block 202, in response to receiving the indication of the ad interaction event, content items relating to the entity and/or ad may be displayed to the user. The content items displayed to a user in response to an interaction event may include content items relating to the ad and/or entity, and/or one or more links to activities and/or services relating to the ad and/or entity. Example activities and services may include direction services, social networking services, review services, entity website, and other content items or services. Example items that may be provided for display at a user client device is illustrated in FIG. 5, described in more detail below.

In block 203, a conversion cookie is provided to the user client device (e.g., the browser in which the object relating to the ad or entity is displayed) in response to the indication. In one example, a request is sent to a third party server to set a conversion cookie for one or more pages associated with the advertisement (e.g., a main page, a landing page, etc.). Cookies are short pieces of data and/or code that can be used to identify a user or web browser. Where cookies identifying a user or user browsing activity are being sent as part of the recording of conversion activity, the user may set whether the browser accepts cookies from one or more entities. In one example, a browser setting may be provided to allow the user to allow cookies from one or more entities or to disable cookies from all entities. In some implementations, the user may choose to receive a notification when a cookie is being sent from an entity to decide whether to allow the cookie. In some examples, mechanisms other than cookies may be used to record conversion activity associated with an ad. In these instances, where user activity is viewable and may be recorded when leading to conversion activity, similar settings may be provided to the user to provide the user notice and/or control of such activity.

In response to the request, a conversion cookie is provided to the client device (e.g., the browser at the client device), without requiring the user to be redirected from the page where the organic content is being displayed, and while the user is interacting with the organic content and/or content items being displayed in response to the interaction. In some embodiments, as described above, a user may adjust the settings indicating whether to allow cookies to be successfully sent to or stored by the browser, and the cookie will only successfully be sent to or stored by the browser based on these settings.

In block 204, an indication of a conversion activity at a website associated with the ad (e.g., a website for which a conversion cookie is provided in block 203), is received. In one example, subsequent to the conversion cookie being provided to the browser, at any time during the life span of the cookie and/or a set conversion period (e.g., 30 days) the browser may receive an indication of a conversion activity when a user visits the website associated with the conversion cookie (e.g., ad landing page). The visit to the website may occur from different sources including the content items displayed in response to an ad, from review sites and/or social networking sites, in response to a search, or by directly typing the name of the website into the browser.

At that time, the conversion cookie (e.g., a modified conversion cookie according to the visit) is retrieved and sent back the browser, for example by the entity that initially set the conversion cookie (e.g., a third party server). The conversion cookie is then provided as an indication of the conversion activity (e.g., to the system recording conversion activities with respect to one or more ads).

In block 205, the indication of conversion activity is received and recorded as a conversion activity associated with the ad. The indication of conversion activity received from the browser may, in some embodiments, be used to determine conversion metrics relating to the ad. In some embodiments, the user will have to apply certain settings or install certain applications in order to take advantage of the techniques described herein.

IV. Example User Interface for Displaying Advertisements to a User

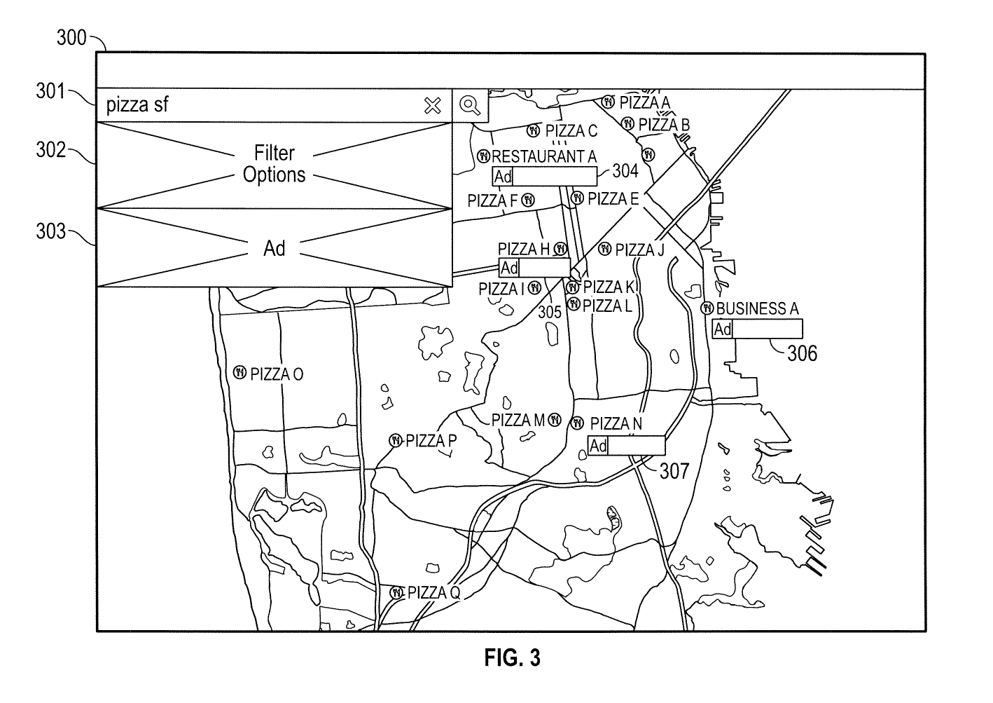

FIG. 3 illustrates an example user interface 300 providing a map displaying map content and ads for display to a user. As illustrated, a map including organic content may be presented to a user. The map may include various map content provided to a user, for example in response to a user search request. For example, as displayed, a search box 301 is provided for entering search criteria for retrieving organic map content to be displayed within the map. For example, a search query “pizza sf” is displayed as being entered in search box 301. A filter card 302 is further displayed. The filter card 302 may provide the user with additional search suggestions, filter criteria and a link to an alternative view of the results (e.g., a list view). An ad card 303 may further display an ad matching the search criteria provided within search box 301. In one example, the ad card 303 may display one of the ads displayed within the map or may include a different ad.

In response to the search query, one or more organic map content (e.g., businesses) matching the criteria is retrieved and provided for display within the map. For example, as displayed one or more pizza restaurants are displayed within the map. One or more other related entities or entities within the vicinity may also be displayed within the map. As illustrated in user interface 300, in one example, ad associated with one or more entities displayed within the map may be retrieved and displayed within the map. For example, as illustrated, in addition to organic map content (e.g., pizza places, restaurants and other business names), one or more entities displayed within the map may include an ad being clustered with the entity and displayed within the map. In one example, the ads may be clustered with the entity associated with the ad and displayed within the map.

For example, as displayed in user interface 300, ads 304, 305, 306 and 307 are displayed. Ad 304 is associated with restaurant A, ad 305 is associated with Pizza H, ad 306 is associated with business A and ad 307 is associated with Pizza N. In one example, each entity and/or ad displayed within the map is selectable by the user. When the user interacts with an entity (e.g., using a user input device) content items associated with the entity is provided for display to the user. In instances where the entity is displayed as clustered with an associated ad (e.g., ad 304, 305, 306 or 307), interaction with the ad and/or entity may cause a conversion cookie to be provided to the browser for recording conversion activity with respect to the ad, for example, in addition to providing the content items for display to the user.

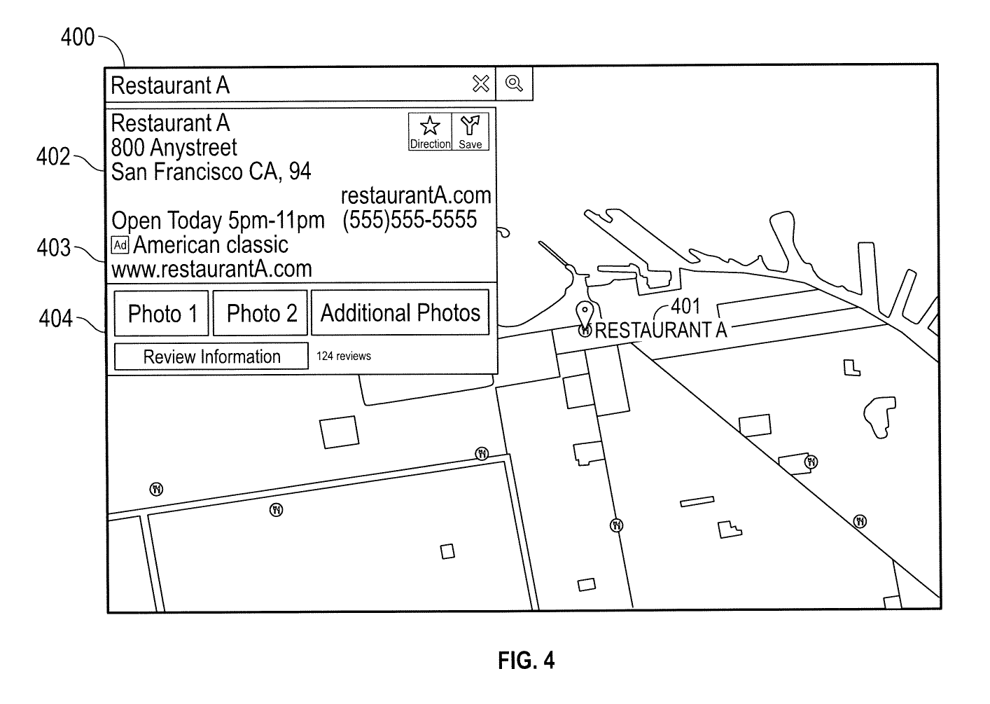

FIG. 4 illustrates an example user interface 400 providing content items for display to a user in response to an ad interaction event. A user may click on an entity or an ad clustered with an entity being displayed on the map. As shown here, a user may interact with a first item 401 (labeled “restaurant A”) displayed on the map. In response to the interaction, content items relating to item 401 may be displayed to the user. For example, an entity card 402 may be displayed including information regarding the entity including for example the address, website, phone number and hours of the business. Furthermore, links to various services such as direction services or links to social networking services may be displayed on the entity card 402. In one example, where the entity is associated with an ad, as displayed in user interface 400, the entity card may further include an ad 403. The ad may include a landing page and ad content. Other information including photos, reviews, and links to various other services may be displayed for example in an auxiliary information area 404.

The user interaction with the item 401 may trigger a conversion cookie to be provided to the browser in relation with the landing page of the ad (e.g., www.resturantA.com). The user may then proceed to view other map content, or to interact with various information and services displayed with respect to the entity. The user does not need to click on or be redirected to the ad landing page and instead can proceed with their experience. At any time after the ad interaction event (e.g., within a conversion period) the user may visit the landing page associated with the ad and may perform a conversion activity. The conversion activity is then recorded and associated with ad 403.

V. Example User Interface for Selecting Conversion Settings

FIG. 5 illustrates an example user interface 500 providing a conversion setting menu that may be provided for display to an advertiser. User interface 500 allows an advertiser to select to follow various sources of conversion activities with respect to an ad. A conversion setting menu 501 is provided including a conversion name area 502 for entering a new conversion setting name, and a conversion source selection area 503 for selecting which sources of conversion activity the advertiser wishes to record. The conversion sources provided in conversion source selection area 502 include “webpage”, “call on-site”, “app download” and “business detail view”. The webpage and business detail view are shown as being selected. The business detail view option, when selected, allows the advertiser to receive conversion activity information when the user performs a conversion activity following an ad interaction event, recorded according to the system and methods described herein. Once the advertiser has selected the types of conversion sources the advertiser wishes to record, the advertiser may select the “save and continue” button 504 to save the conversion setting.

VI. Example System for Recording Conversion Activity Relating to Advertisements

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

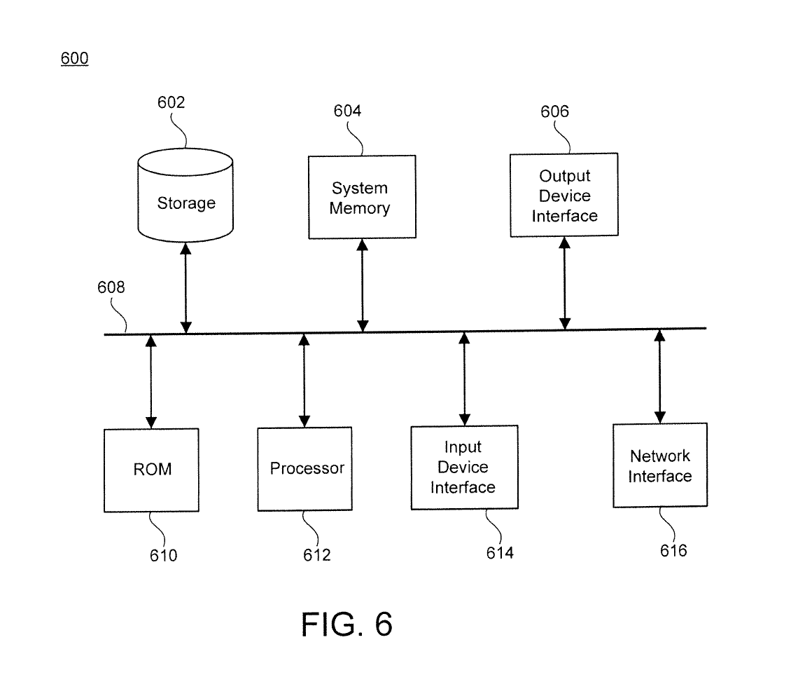

FIG. 6 conceptually illustrates an electronic system with which some implementations of the subject technology are implemented. Electronic system 600 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 600 includes a bus 608, processing unit(s) 612, a system memory 604, a read-only memory (ROM) 610, a permanent storage device 602, an input device interface 614, an output device interface 606, and a network interface 616.

Bus 608 collectively represents all system, peripheral, and chipset buses that communicatively connect the numerous internal devices of electronic system 600. For instance, bus 608 communicatively connects processing unit(s) 612 with ROM 610, system memory 604, and permanent storage device 602.

From these various memory units, processing unit(s) 612 retrieves instructions to execute and data to process in order to execute the processes of the subject disclosure. The processing unit(s) can be a single processor or a multi-core processor in different implementations.

ROM 610 stores static data and instructions that are needed by processing unit(s) 612 and other modules of the electronic system. Permanent storage device 602, on the other hand, is a read-and-write memory device. This device is a non-volatile memory unit that stores instructions and data even when electronic system 600 is off. Some implementations of the subject disclosure use a mass-storage device (such as a magnetic or optical disk and its corresponding disk drive) as permanent storage device 602.

Other implementations use a removable storage device (such as a floppy disk, flash drive, and its corresponding disk drive) as permanent storage device 602. Like permanent storage device 602, system memory 604 is a read-and-write memory device. However, unlike storage device 602, system memory 604 is a volatile read-and-write memory, such a random access memory. System memory 604 stores some of the instructions and data that the processor needs at runtime. In some implementations, the processes of the subject disclosure are stored in system memory 604, permanent storage device 602, and/or ROM 610. For example, the various memory units include instructions for recording conversions resulting from an ad based on user interaction with an ad according to various embodiments. From these various memory units, processing unit(s) 612 retrieves instructions to execute and data to process in order to execute the processes of some implementations.

Bus 608 also connects to input and output device interfaces 614 and 606. Input device interface 614 enables the user to communicate information and select commands to the electronic system. Input devices used with input device interface 614 include, for example, alphanumeric keyboards and pointing devices (also called “cursor control devices”). Output device interfaces 606 enables, for example, the display of images generated by the electronic system 600. Output devices used with output device interface 606 include, for example, printers and display devices, such as cathode ray tubes (CRT) or liquid crystal displays (LCD). Some implementations include devices such as a touchscreen that functions as both input and output devices.

Finally, as shown in FIG. 6, bus 608 also couples electronic system 600 to a network (not shown) through a network interface 616. In this manner, the computer can be a part of a network of computers (such as a local area network (“LAN”), a wide area network (“WAN”), or an Intranet, or a network of networks, such as the Internet. Any or all components of electronic system 600 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that some illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method for recording conversion activity, the method comprising:
detecting, by one or more computing devices, a user interaction with an object displayed in a webpage within a browser of a user client device, the object associated with an entity and at least one advertisement embedded in map content of the webpage, wherein the user interaction comprises an interaction with the object via an input device operated by a user and corresponds to one or more predefined events that occur within the webpage, and wherein the one or more predefined events comprise an expansion of the at least one advertisement that causes one or more content items relating to the entity to be displayed on the user client device;
responsive to the detection of the user interaction, providing, by the one or more computing devices, the one or more content items associated with the object displayed in the map content of the webpage within the browser of the user client device, wherein the one or more content items are displayed and comprise the advertisement clustered with an identifier associated with the entity;
providing, by the one or more computing devices, a conversion cookie to the user client device for the at least one webpage in response to the detection of the user interaction corresponding to the one or more predefined events that occur within the webpage;
receiving, by the one or more computing devices, at a time after the providing of the conversion cookie, an indication of a conversion activity that is associated with the object and occurred in response to detection of the user performing the conversion activity; and
recording, by the one or more computing devices, the conversion activity that is associated with the object.

2. The method of claim 1, wherein the conversion cookie is provided to the browser at the user client device.

3. The method of claim 1, wherein the conversion activity comprises a user activity defined by the entity as a desired activity.

4. The method of claim 1, wherein providing the conversion cookie comprises requesting a third party server to provide the conversion cookie at the browser.

5. The method of claim 1, wherein the providing the one or more content items comprises displaying the one or more content items along with the object.

6. The method of claim 1, wherein the content items comprise information regarding the entity.

7. The method of claim 1, wherein the user interaction comprises the user clicking a graphical representation of the object being provided for display.

8. The method of claim 1, wherein the user interaction comprises the user clicking a graphical representation of an entity associated with the object being provided for display.

9. The method of claim 1, wherein the one or more content items comprises a micro-site representing the webpage.

10. The method of claim 9, wherein the setting the conversion cookie comprises setting a conversion cookie at the micro-site.

11. A system for recording conversion activity in response to advertisements, the system comprising:
one or more processors; and
a machine-readable medium comprising instructions stored therein, which when executed by the processors, cause the processors to perform operations comprising:
receiving an indication of a user interaction with an object associated with an ad provided for display at a user device, wherein the ad is associated with an entity;
providing one or more content items relating to the entity for display at the user client device in response to the indication of user interaction;
providing a conversion cookie to the user client device for at least one webpage associated with the ad in response to the indication of user interaction with the entity without redirecting the user to the at least one webpage; and
receiving, at a time after the providing of the conversion cookie, an indication of a conversion activity by a user following the user visiting the at least one webpage at the client device;
associating the conversion activity with the ad.

12. The system of claim 11, wherein the object is provided for display at a first webpage, and wherein the one or more content items are displayed at the first webpage.

13. The system of claim 11, wherein the providing the conversion cookie comprises providing the conversion cookie to a browser at the user device, and wherein the indication of the conversion activity is received from the browser.

14. The system of claim 11, wherein providing the conversion cookie comprises requesting a third party server to provide the conversion cookie to a browser at the user device in response to the indication of user interaction.

15. The system of claim 11, wherein the content items comprise information regarding the entity or the ad.

16. The system of claim 11, wherein the conversion cookie provides an indication of a conversion activity when a conversion activity occurs in response to a user at the client device visiting the at least one webpage.

17. The system of claim 11, wherein the object comprises a graphical representation of one or more of the ad or the entity associated with the ad.

18. A machine-readable medium comprising instructions stored therein, which when executed by a machine, cause the machine to perform operations comprising:
receiving a request to monitor conversion activity with respect to an ad in response to user interaction with the ad;
providing the ad for display to one or more users at one or more user devices;
receiving an indication of a user interaction with the ad at at least one user device of the one or more user devices, the user interaction comprising an expansion of the ad, the expansion causing one or more content items relating to an entity relating to the ad for display at the at least one user client device;
providing a conversion cookie to the at least one user device for at least one webpage associated with the ad in response to the indication of user interaction with the ad without redirecting the user to the at least one webpage; and
receiving, at a time after the providing of the conversion cookie, an indication of a conversion activity in response to a user visiting the at least one webpage at the at least one user device;
associating the conversion activity with the ad in response to the indication of the conversion activity.

19. The machine-readable medium of claim 18, the operations further comprising:
generating metrics regarding the conversion activity relating to the ad based on the user interaction with the ad at the one or more user devices.

20. The machine readable medium of claim 18, wherein the object is provided for display at a first webpage, and wherein the one or more content items are displayed at the first webpage.
